(19) United States
(12) Patent Application Publication
(10) Pub. No.: US 2013/0197993 A1
(43) Pub. Date: Aug. 1, 2013

(54) Advertiser Modeling

(71) Applicants: Bin Gao, Beijing (CN); Tie-Yan Liu, Beijing (CN)

(72) Inventors: Bin Gao, Beijing (CN); Tie-Yan Liu, Beijing (CN)

(73) Assignee: Microsoft Corporation, Redmond, WA (US)

(21) Appl. No.: 13/358,955

(22) Filed: Jan. 26, 2012

(51) Int. Cl. G06Q 30/02; G06Q 30/08

(52) U.S. Cl. 705/14.45; 705/14.41; 705/14.71

(57) ABSTRACT

In a system that supports paid advertisements, as advertisements are awarded ad spots based on contextual relevance to search queries, periodic performance indicators are recorded. The periodic performance indicators represent ad performance during a specific time period. Over time, the periodic performance indicators are aggregated to form historical behavior indicators. A graphical model of advertiser behavior is formulated based on the periodic performance indicators and the historical behavior indicators. The graphical model may then be used to forecast future bid values based on previous advertiser behavior.

### BACKGROUND

Many Internet search engines support paid advertisements, which are displayed contextually with results to user-submitted search queries. In practice, advertisers typically provide the search engine provider with an ad, a keyword, and a bid price. When a user submits a query that includes the keyword, or in some cases a similar keyword, the ad is identified as a candidate ad for display with the search results. There may be, for example, three ad spots available on the search results display and 15 ads that are identified as being contextually relevant candidates. Those 15 ads are then ordered based, at least in part, on the bid price. The top three ads are then selected for display with the search results.

In many instances, an advertiser creates an ad campaign with specific campaign goals. For example, the advertiser may create an ad with an associated keyword, and a goal of receiving 100 clicks on the ad during a week. If, after three days, the ad has only received five clicks, the advertiser may choose to modify some combination of the ad, the keyword, and/or the bid price, with changes in bid price typically being the most common adjustment made by advertisers. By making such an adjustment, the advertiser attempts to increase the chances that the ad will be displayed, and thus increase the chances that the ad will receive additional clicks.

### SUMMARY

This document describes advertiser modeling. For a given ad, changes in bid values and periodic performance indicators, which reflect ad performance during a period of time, are recorded over multiple successive time periods. The periodic performance indicators are aggregated to form historical behavior indicators, which reflect changes in ad performance from one time period to another. Based on the recorded changes in bid values, periodic performance indicators, and historical behavior indicators, an advertiser model is generated. The advertiser model enables forecast of future bid values based on past advertiser behavior with regard to changes in bid values.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 is a pictorial diagram of an example environment in which advertiser modeling may be implemented.

FIG. 2 is a flow diagram that illustrates an example operation process of a search engine provider.

FIG. 3 is a block diagram of an example combination of factors to forecast changes in bid values.

FIG. 4 is a flow diagram that illustrates an example generative process of an advertiser model.

FIG. 5 is a pictorial diagram that illustrates a graphical advertiser model.

### DETAILED DESCRIPTION

Paid advertisements that are displayed contextually along with search results provide a convenient way for advertisers to target their marketing efforts, and provide revenue to search engine providers. In such a system, advertisers bid for available ad spots that are displayed with search results. The more an advertiser is willing to pay, and thus the higher their bid, the greater the chance that their ad will be frequently displayed. At the same time, advertisers want to keep their bids as low as possible while still achieving a goal of the ad campaign.

When a new advertiser submits an ad to a search engine provider, the advertiser may not have enough information to make an informed decision regarding how much to bid. As a result, the advertiser may spend several days, or even several weeks, frequently modifying their bid value in an effort to minimize cost while achieving their desired results. In this scenario, it is beneficial if the search engine provider can suggest an appropriate bid price. However, if the advertiser suspects that the search engine provider is recommending an unnecessarily high bid price, in an effort to increase the search engine provider's revenue, the advertiser may become dissatisfied and move their business to another search engine provider.

An advertiser model can enable a search engine provider to forecast future bid values and make reasonable bid value recommendations. However, there are several challenges to advertiser modeling. For example, the ad campaign goals of particular advertisers are typically unknown to the search engine provider. As such, there is no way for the search engine provider to know whether or not the results of a particular ad (e.g., number of impressions, number of clicks, cost per click being charged, etc.) are meeting the advertiser's goals.

Another challenge is based on different advertiser styles with regard to ad campaigns. For example, some advertisers frequently adjust bid values based on recent ad performance, while other advertisers may submit an ad with a bid value and never change the bid value, regardless of the performance of the ad. Additionally, advertisers who do change their bid values may do so based solely on short term results, without considering long-term trends.

Furthermore, a change in a bid value does not necessarily result in a change in campaign performance. For example, market forces (e.g., the release of an updated high-tech gadget) may drive user-submitted queries containing specific keywords. While the user demand is high, higher bid values may result in better ad campaign results. However, after user demand wanes, advertisers who submit higher bid values may not see significant changes in ad campaign results, because the frequency of relevant user queries may decrease. As another example, as the Christmas season approaches, an advertiser may increase their bid value for ads associated with a keyword of “Christmas” or “gift” in an effort to increase the number of impressions for those ads. However, many other advertisers may also increase their bids associated with these keywords for the same reason. Accordingly, the increased bid value associated with these keywords may not have the desired result.

Some existing efforts to model advertiser behavior rely on a number of assumptions. For example, a model may assume that each advertiser has complete information of a particular auction, may assume that each advertiser is making an effort to optimize their performance, and may assume that each advertiser is optimizing each individual auction. However, in reality, advertisers typically do not have complete information. Rather, advertisers typically have access to aggregate data (e.g., number of impressions or clicks during a particular period of time), and if they are going to adjust bid values, they do so based on the aggregate data at the end of the time period.

Other modeling assumptions may include a simplified setting (e.g., a single ad slot and only two advertisers), an assumption that other advertisers do not change their bid values, and/or an assumption that all of the advertisers apply the same bid strategy. Because the above assumptions are inconsistent with actual advertiser behavior, models based on any combination of the above assumptions are also inconsistent with real data.

A mechanism is described herein to model bid price trends over time based on aggregated data that is typically available to advertisers. A model of bid price trends may then be used to infer market dynamics associated with various keywords and to forecast future winning bid prices associated with particular keywords. This information can then be used by a search engine provider to recommend bid prices to new advertisers such that the recommended bid prices will likely be viewed by the advertisers as appropriate, thereby increasing advertiser satisfaction.

### Example Environment

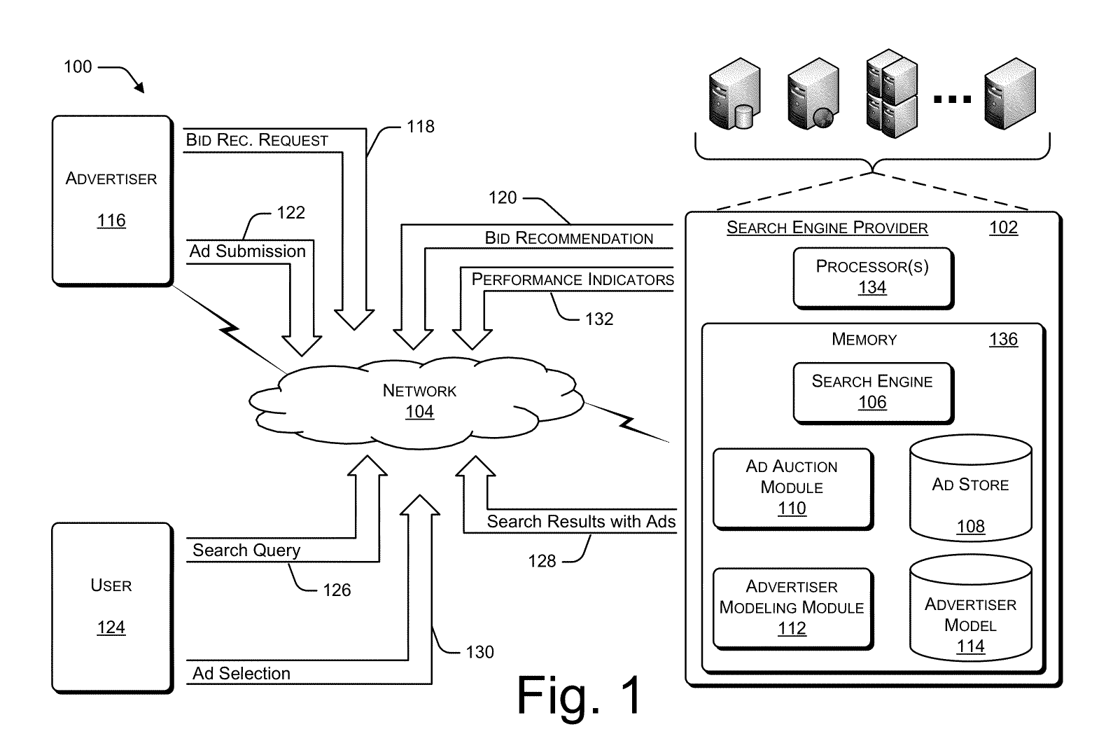

FIG. 1 illustrates an example environment 100 usable to implement advertiser modeling. Example environment 100 includes search engine provider 102 that provides a search service over a network 104, which is representative of, for example, the Internet or any other type of public or private network. In an example implementation, search engine provider 102 may be implemented, for example, as any combination of one or more server computer systems, including, but not limited to, a database server, a web server, an application server, and the like. Example search engine provider 102 includes search engine 106, ad store 108, ad auction module 110, advertiser modeling module 112, and advertiser model 114.

In an example scenario, an advertiser 116 interacts with search engine provider 102 to submit an ad for contextual display with search results. For example, advertiser 116 may initially submit a bid recommendation request 118 over the network 104 to search engine provider 102. In an example implementation, when an advertiser is submitting a new ad, or an ad to be associated with a new keyword, the advertiser may submit the keyword to be associated with the ad, and request that the search engine provider make a recommendation regarding an appropriate bid value to assign to the ad/keyword pair. In alternate implementations, the bid recommendation request may include a variety of information, including, but not limited to, a keyword, a budget amount, and an ad campaign goal. Search engine provider 102 may use any combination of information submitted as part of the bid recommendation request to determine a recommended bid value. The bid recommendation 120 is then transmitted from search engine provider 102 to advertiser 116 over network 104.

After deciding on a bid value, which may or may not be based on bid recommendation 120, advertiser 116 sends ad submission 122 to search engine provider 102 over network 104. In an example implementation, ad submission 122 includes at least an ad, a keyword, and a bid value. In alternate implementations, ad submission 122 may also include additional information such as, but not limited to, an ad campaign goal, an ad campaign budget, an expiration date/time of the ad campaign, and so on. Search engine provider 102 stores data from ad submission 122 in ad store 108.

A user 124, desiring to conduct a network search (e.g., an Internet search), accesses search engine 106, and enters a search query 126 through a user interface provided by search engine 106. Upon receiving search query 126, search engine 106 identifies search results to be presented for the user through the user interface. In addition, ad auction module 110 awards one or more ad spots in the user interface to one or more corresponding ads from ad store 108 based, at least in part, on search query 126, the keywords associated with the ads, and the bid values associated with the ads. After ad auction module 110 awards the one or more ad spots to particular ads, search engine 106 returns the search results and ads 128.

Upon viewing the user interface display of the search results with ads 128, user 124 may submit ad selection 130, for example, by clicking on, or otherwise selecting, a particular one of the displayed ads. Search engine provider 102 stores an indication of ad selection 130 and then may redirect a computing device of user 124 to a site (e.g., a website) associated with the selected ad or may otherwise surface content associated with the ad on the computing device of user 124.

As part of the ad auction process, search engine provider 102 tracks various data which are then used, for example, to generate invoices for the advertisers. For example, search engine provider 102 may track, for each ad, a number of impressions, a number of clicks, and amount charged for each click. These performance indicators 132 may then be provided to advertiser 116 over network 104.

As searches and ad auctions are performed over time, performance indicators associated with the various ads in ad store 108 are gathered and advertiser modeling module 112 creates and updates advertiser model 114.

As mentioned above, search engine provider 102 may be implemented using any combination of one or more computer systems. In an example implementation, search engine provider 102 includes one or more processors 134, which may be distributed across multiple computing devices. Search engine provider 102 also includes one or more memory components 136.

Any one or more of search engine 106, ad auction module 110, ad store 108, advertiser modeling module 112, and advertiser model 114 may be stored, at least in part, in memory 136 as computer readable instructions, which may be executed by processor(s) 134.

Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

As illustrated in FIG. 1, memory 136 is an example of computer storage media.

### Example Operation

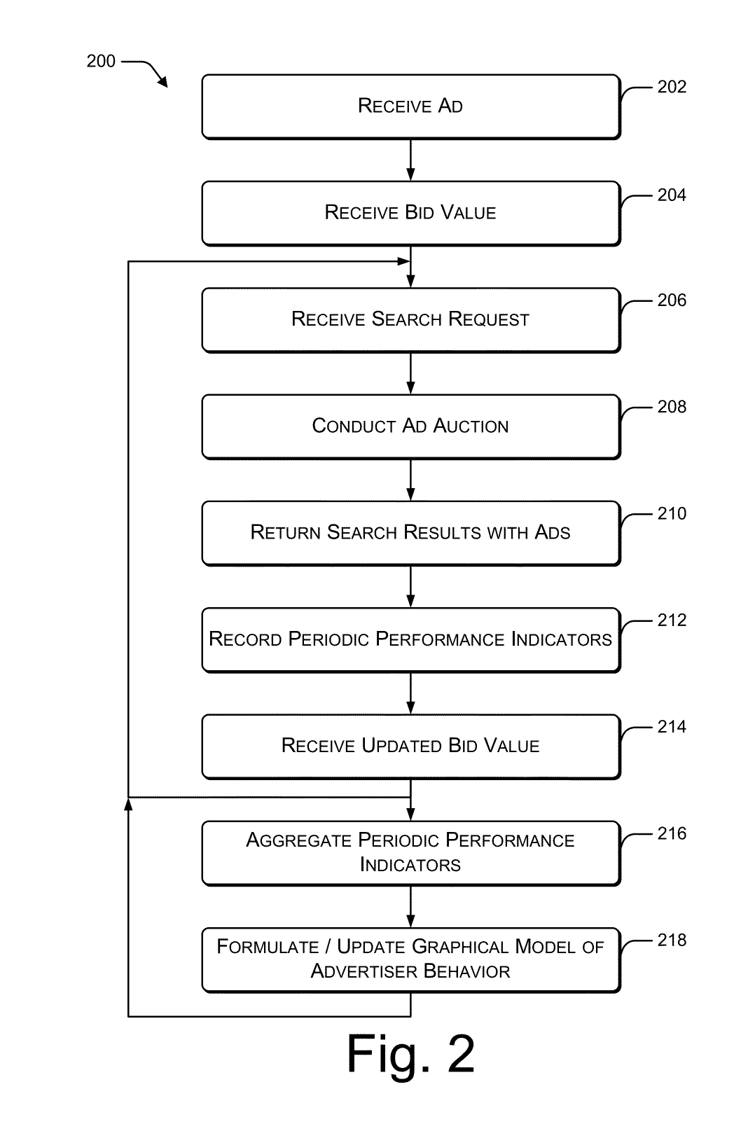

FIG. 2 illustrates an example operation process 200 of search engine provider 102. This process is illustrated as a collection of blocks in a logical flow graph, which represents a sequence of operations that can be implemented in hardware, software, or a combination thereof In the context of software, the blocks represent computer-executable instructions that may be stored on one or more computer storage media that may be executed by one or more processors to cause the processors to perform the recited operations. Note that the order in which the process is described is not intended to be construed as a limitation, and any number of the described process blocks can be combined in any order to implement the process, or alternate processes. Additionally, individual blocks may be deleted from the processes without departing from the spirit and scope of the subject matter described herein. Furthermore, while this process is described with reference to the search engine provider 102 described above with reference to FIG. 1, other computer architectures may implement one or more portions of this process, in whole or in part.

At block 202, an ad is received. For example, ad submission 122 is received from advertiser 116. In an example implementation, the ad that is received may include an <ad, keyword> pair.

At block 204, a bid value is received in association with the ad. For example, advertiser 116 specifies a bid value to be associated with the <ad, keyword> pair. The bid value represents a maximum amount that the advertiser is willing to pay when the ad is presented with search results (e.g., ad impression) and/or when the ad is selected by a user after being presented with search results (e.g., ad click).

At block 206, a search request is received. For example, search query 126 is received from user 124 over network 104. The search query may be, for example, a word or phrase against which an Internet search is to be conducted.

At block 208, an ad auction is conducted. For example, ad auction module 110 compares the received search request with keywords associated with ads in ad store 108 to identify candidate ads based on contextual relevance to the search query. The candidate ads are then ordered based, at least in part, on bid value, and a winning ad for each available ad slot is determined.

At block 210, search results with ads are returned. For example, the results of an Internet search based on the search query 126, along with the winning ad for each available ad slot is returned to the user.

At block 212, periodic performance indicators associated with the ad are recorded. For example, as ads are returned along with the query results, ad auction module 110 gathers statistics regarding ad impressions, ad clicks, charges to the advertiser, and so on. These performance indicators are maintained in ad store 108.

At block 214, an updated bid value is received in association with the ad. For example, after reviewing performance indicators 132, advertiser 116 may submit a modified bid value, either increasing or decreasing the previous bid value.

As indicated by the loop from block 214 to block 206, periodic performance indicators continue to be recorded for the ad, now having the updated bid value.

At block 216, the periodic performance indicators are aggregated to generate historical behavior indicators. For example, advertiser modeling module 112 aggregates the periodic performance indicators over multiple time periods, resulting in historical behavior indicators. As an example, the periodic performance indicators may include a number of impressions associated with the ad during a particular time period. The historical behavior indicators may include a difference in number of impressions associated with the ad from one time period to another time period. While the periodic performance indicators represent ad performance during a particular time period, the historical behavior indicators represent changes in ad performance over time.

At block 218, a graphical model of advertiser behavior is formulated and/or updated. For example, advertiser modeling module 112 uses the periodic performance indicators and the historical behavior indicators to generate a graphical model of advertiser behavior associated with the ad. The graphical model is based on data recorded over time in association with the ad. As such, as additional data is recorded, the graphical model is updated to account for the additional data.

Once formulated, the graphical model of advertiser behavior can be used to forecast changes in bid values associated with the ad from one time period to another.

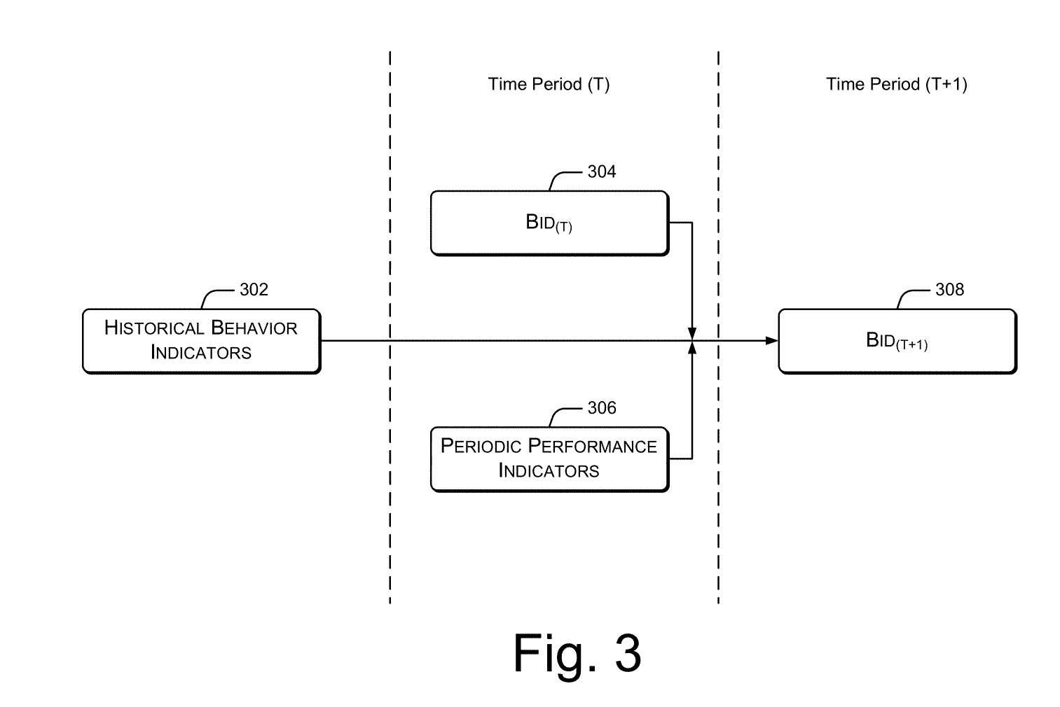

FIG. 3 illustrates an example combination of factors to forecast changes in bid values. For any particular <ad, keyword> pair, historical behavior indicators (HBI) 302 are combined with a bid value 304 during a first time period, T, and with periodic performance indicators (PPI) 306 from the first time period, T. This combination of bid value, historical behavior indicators, and periodic performance indicators provides a forecast bid value 308 for an upcoming time period (T+1).

Time period (T) may be any suitable time period, such as a day, a week, or a month. Bid value 304 represents a bid value during time period (T), which may be an average bid value. Using an average bid value, as opposed to a specific bid value, accounts for advertiser-submitted changes in bid values during time period (T) and for variances in bid values specified for various types of keyword matches. In an example implementation, a search engine may allow an advertiser to specify multiple bid values for a particular <ad, keyword> pair, depending on how well the keyword matches a user-submitted query. For example, an advertiser may specify a higher bid value for use when the keyword exactly matches a user-submitted query, a lower bid value for use when the keyword broadly matches a user-submitted query (e.g., the keyword is a synonym of a word in the query or an alternate form of a word in the query), a still lower bid value for use when the keyword is part of a phrase in the search query, and an even lower bid value for use when the keyword is matched to the search query by similarity of content. If an advertiser submits four such bid values for various types of query matches, bid value 304 may represent an average of those four bid values.

Periodic performance indicators (PPI) 306 are data points associated with an <ad, keyword> pair during a specific time period, which are typically made available to the advertiser. PPI 306 enable the advertiser to see the performance results of the <ad, keyword> pair during that specific time period. Table 1, below, lists examples of periodic performance indicators 306.

TABLE 1

| Periodic | |
|---|---|
| Performance | |
| Indicator | Description |
| ImpressionNum | Number of impressions during time period (T) |
| ClickNum | Number of clicks during time period (T) |
| SumCharged | Total amount charged during time period (T) |
| AvgCharged | Average cost per click during time period (T) |
| AuctionNum | Number of ad auctions in which the <ad, keyword> |
| | pair was a candidate during time period (T) |

Over time, PPI are aggregated across multiple time periods, creating historical behavior indicators (HBI) 302. Examples of HBI 302 are listed below in Table 2.

TABLE 2

| Historical Behavior | |
|---|---|
| Indicator | Description |
| BudgetAmt | Ad campaign budget |
| ImpressionNumDif | Difference in number of impressions during |
| | time period (T) and number of impressions |
| | during a previous time period (T-1) |
| ClickNumDif | Difference in number of clicks during time |
| | period (T) and number of clicks during a |
| | previous time period (T-1) |
| ActualBidDif | Difference in average actual bid during time |
| | period (T) and average actual bid during time |
| | period (T-1) |
| SumChargedDif | Difference in total amount charged during time |
| | period (T) and total amount charged during |
| | time period (T-1) |
| AvgChargedDif | Difference in average cost per click during time |
| | period (T) and average cost per click during a |
| | previous time period (T-1) |
| ECount | Exact match bid change frequency over time |
| | period (T′) |
| BCount | Broad match bid change frequency over time |
| | period (T′) |
| PCount | Phrase match bid change frequency over time |
| | period (T′) |
| CCount | Content match bid change frequency over time |
| | period (T′) |

Time period (T′), mentioned in Table 2 with reference to historical behavior indicators ECount, BCount, PCount, and CCount, represents an aggregate time period. For example, if time period (T) has a duration of one week, time period (T′) represents a longer time period of, for example, two weeks, five weeks, 20 weeks, or the like.

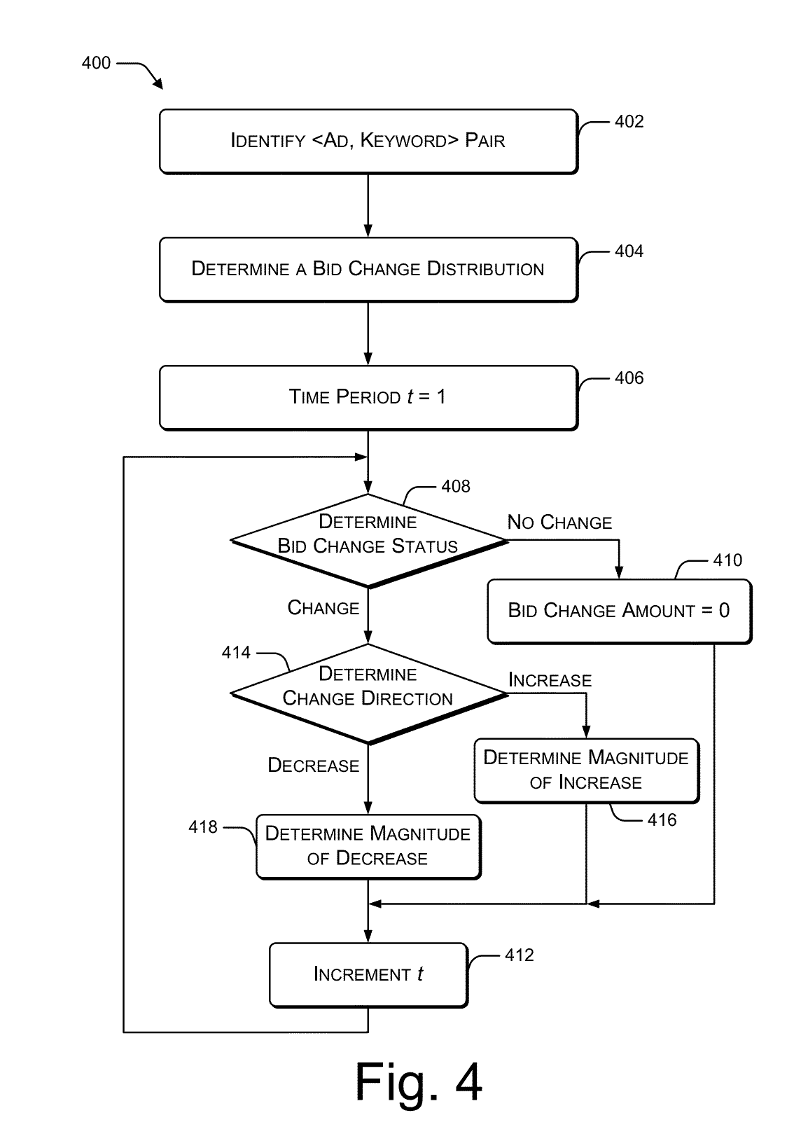

FIG. 4 illustrates an example generative process of an advertiser model. This process is illustrated as a collection of blocks in a logical flow graph, which represents a sequence of operations that can be implemented in hardware, software, or a combination thereof. In the context of software, the blocks represent computer-executable instructions that may be stored on one or more computer storage media that may be executed by one or more processors to cause the processors to perform the recited operations. Note that the order in which the process is described is not intended to be construed as a limitation, and any number of the described process blocks can be combined in any order to implement the process, or alternate processes. Additionally, individual blocks may be deleted from the processes without departing from the spirit and scope of the subject matter described herein. Furthermore, while this process is described with reference to the search engine provider 102 described above with reference to FIG. 1, other computer architectures may implement one or more portions of this process, in whole or in part.

The process illustrated in FIG. 4 may be performed for each <ad, keyword> pair for each advertiser. Alternatively, the process may be performed across multiple <ad, keyword> pairs for a particular advertiser (e.g., <ad, keyword> pairs having the same ad or <ad, keyword> pairs having the same keyword), or the process may be performed for particular <ad, keyword> pairs having the same keyword across multiple advertisers.

At block 402, an <ad, keyword> pair is identified. For example, advertiser modeling module 112 selects a particular <ad, keyword> pair from ad store 108.

At block 404, a bid change distribution for the selected <ad, keyword> pair is determined. The bid change distribution is based, in large part, on HBI associated with the selected <ad, keyword> pair. For example, the historical behavior indicator, ActualBidDif, is examined across multiple time periods. As described above, for a particular time period, T, the ActualBidDif is the difference between the average bid value during time period T−1 and the average bid value during time period T. An ActualBidDif of zero indicates that the average bid value did not change from time period T to time period T−1. Similarly, an ActualBidDif that is greater than zero indicates that the average bid value increased from time period T−1 to time period T, while an ActualBidDif that is less than zero indicates that the average bid value decreased from time period T−1 to time period T.

As discussed above, the time periods T and T−1 may be of any appropriate duration. For ease of discussion, assume each time period is one day, and assume that there is data available for a particular <ad, keyword> pair spanning 100 days. In this example, there are 100 ActualBidDif values available. To determine the bid change distribution, the number of non-zero ActualBidDif values (indicating a change in the bid value) is compared to the number of times the ActualBidDif is equal to zero (indicating no change in the bid value).

As an example, if, over 100 time periods, the bid value was changed 35 times and not changed 65 times, then the bid change distribution would be (0.35, 0.65), indicating that for the given <ad, keyword> pair, the advertiser has a probability of 0.35 to change the bid between a current time period and a next time period. Similarly, there is a probability of 0.65 that the advertiser will not change the bid from the current time period to the next time period.

At block 406, a loop is initialized to step through the time periods for which historical data is available for the identified <ad, keyword> pair. For example, a variable, t, is initialized to one, indicating the first time period for which data is available.

At block 408, a bid change status is determined. The bid change status indicates whether or not the bid value is to change from the current time period t to the next time period t+1.

If the bid change status for the current time period t indicates no change, then at block 410, a bid change amount is set to zero.

At block 412, the time period t is incremented to t+1, and processing continues as described above at block 408.

On the other hand, if, at block 408, the bid change status for time period t indicates a change, then at block 414, a change direction is determined. As described above, if the bid value changes between time period t and time period t+1, the bid value could either increase or decrease. As will be discussed in further detail below, whether or not the bid will increase or decrease may be based on a change direction distribution, which is based, in large part, on current PPI.

If the change direction determined at block 414 indicates an increase, then at block 416, a magnitude of increase is determined Similarly, if the change direction determined at block 414 indicates a decrease, then at block 418, a magnitude of decrease in determined. As will be discussed in further detail below, the magnitude of an increase is determined based on current PPI and a particular function/strategy. Similarly, the magnitude of decrease is also determined based on current PPI and another particular function/strategy.

At block 412, the time period t is then incremented to t+1, and processing continues as described above with reference to block 408.

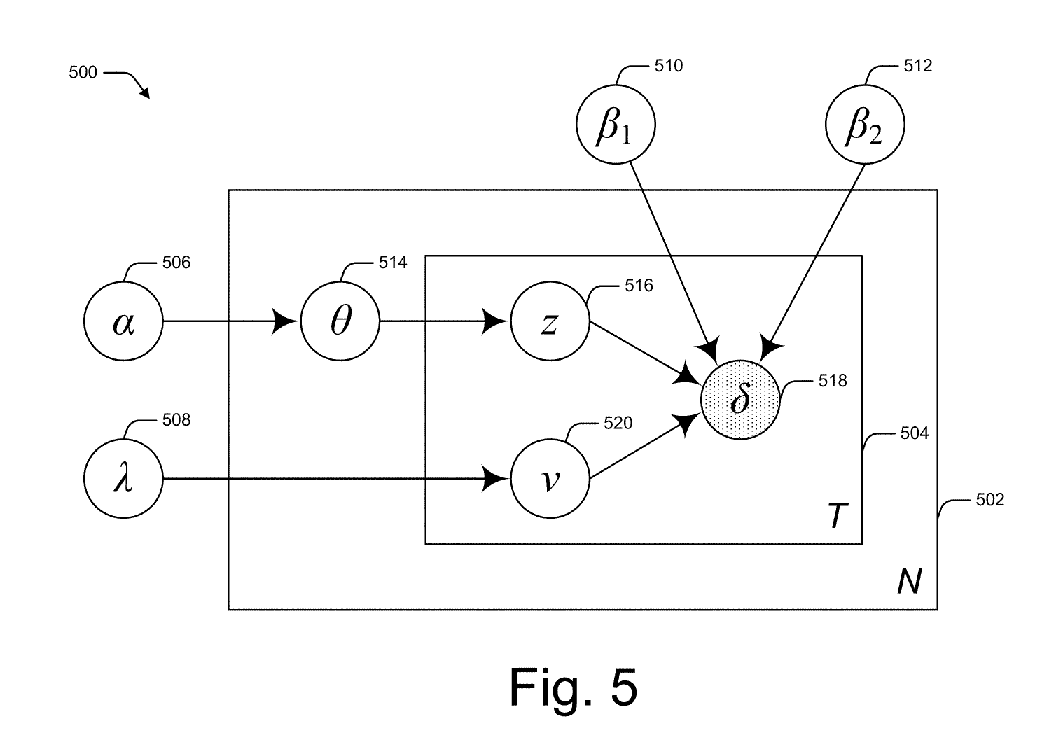

FIG. 5 illustrates a graphical advertiser model that corresponds to the example generative process illustrated in FIG. 4. The graphical model 500 is based on a latent Dirichlet allocation, which provides a generative probabilistic model for collections of discrete data. Latent Dirichlet allocation is described in Blei, et al., “Latent Dirichlet Allocation” in: Journal of Machine Learning Research 3 (January 2003), pp. 993-1022.

Notations used in the description of model 500 include the following:

<ad, keyword> pair: dₙ ∈ D, (n=1, . . . , N)

Time period: t, where (t=1, . . . , T)

Periodic performance indicators: k, where (k=1, . . . , K)

Historical behavior indicators: 1, where (l=1, . . . , L)

Bid value of dₙ in time period t: bₙ^{(t)}

PPI of dₙ in time period t: xₙ^{(t)}=(xₙ₁^{(t)}, xₙ₂^{(t)}, . . . , x_{nK}^{(t)})^{T}

HBI of dₙ in time period t: yₙ^{(t)}=(yₙ₁^{(t)}, yₙ₂^{(t)}, . . . , y_{nL}^{(t)})^{T}

Bid change distribution of dₙ: θₙ

Bid change status: zₙ^{(t)} ∈ (Change, NoChange)

Bid change direction: υₙ^{(t)} ∈ (Increasae, Decrease)

Bid change amount: δₙ^{(t)}=bₙ^{(t)}−b_{b}^{(t-1)}

Parameter for bid change distribution: α

Parameter matrices for bid change amount: β₁, β₂

Parameter for change direction distribution: λ

Plate 502 represents the available <ad, keyword> pairs dₙ, where n=1, 2, . . . , N. Plate 504 represents time, with each time slot denoted as t, where t=1, 2, . . . , T.

Parameter α 506 is a function of historical behavior indicators such that α=f(yₙ^{(t)}). Similarly, parameters λ, β₁, and β₂ are each a function of periodic performance indicators such that: λ=g(xₙ^{(t)}) and βᵢ=hᵢ(xₙ^{(t)}), i=1, 2. In an example implementation, a 506 reflects historical indicators of whether or not the bid value changed from one time period to the next; λ 508 reflects historical indicators of whether the bid value was increased or decreased when the bid value changed from one time period to the next; β₁ 510 is a function that reflects historical bid value change magnitudes when the bid value was increased from one time period to the next; and β₂ 512 is a function that reflects historical bid value change magnitudes when the bid value was decreased from one time period to the next. Parameters β₁ and β₂ may each consider any number or combination of historical behavior indicators. In an example implementation, the function on which parameter is based may give more weight to the ImpressionNumDif and ClickNumDif values, while the function on which parameter β₂ is based may give more weight to the SumChargedDif and AvgChargedDif values. Alternate implementations may weight the impact of the various HBI values differently.

The bid change distribution (θ) 514 is determined for each <ad, keyword> pair, dₙ (represented by plate 502), based on parameter α 506. In an example implementation, the bid change distribution is a Dirichlet distribution such that θₙ˜Dir(α).

Based on the bid change distribution (θ) 514, the bid change status (z) 516 is determined for each time period t (represented by plate 504). In an example implementation, the bid change status is given by a Bernoulli distribution, zₙ^{(t)}˜Ber(θₙ). Accordingly, if an increasing number of bid change status values are selected, the distribution of selected change status values will trend toward a distribution that corresponds to the bid change distribution.

If zₙ^{(t)} is “NoChange”, then the bid change amount (δ) 518 is given by: δₙ^{(t)}=0.

If zₙ^{(t)} is “Change”, then a change direction is determined. Change direction (υ) 520 is based on parameter λ 508. In an example implementation, the change direction is given by a Bernoulli distribution, υₙ^{(t)}˜Ber(λ).

If υₙ^{(t)} is “Increase”, then the bid change amount is given by: δₙ^{(t)}˜p(δₙ^{(t)}|υₙ^{(t)}, β₁). Similarly, if υₙ^{(t)} is “Decrease”, then the bid change amount is given by: δₙ^{(t)}˜p(δₙ^{(t)}|υₙ^{(t)}, β₂).

The model illustrated and described above with reference to FIGS. 4 and 5 provides an inference method for forecasting bid values. For example, the model described above provides support for the following formulas:

### Joint Distribution:

p(θₙ, zₙ, υₙ, δₙ|α, β₁, β₂, λ)=p(θₙ/α)πₜ₌₁^{T}p(z^{(t)}|θₙ)p(υₙ^{(t)}|λ)Σᵢ₌₁²p(δₙ^{(t)}|zₙ^{(t)}, υₙ^{(t)}, β₁)

### Integration and Sum:

p(δₙ|α, β₁, β₂, λ)=∫p(θₙ|α) (πₜ₌₁^{T}Σ_{z}_{_{n,}}_{υ}_{ₙ}(p(zₙ^{(t)}|θₙ)p(υₙ^{(t)}|λ)Σᵢ₌₁²p(δₙ^{(t)}|zₙ^{(t)}, υₙ^{(t)}, βᵢ))dθₙ

Probality of a set of <ad, keyword> pairs:

p(D|α, β₁,β₂, λ)=πₜ₌₁^{T}Σ_{z}_{_{n,}}_{υ}_{ₙ}(p(zₙ^{(t)}|θₙ)(p(υₙ^{(t)}|λ)Σᵢ₌₁²p(δₙ^{(t)}|zₙ^{(t)}, υₙ^{(t)}, βᵢ)))dθₙ

### CONCLUSION

The generative probabilistic advertiser described herein models advertiser behavior with regard to bid value changes over time based on performance indicators that are typically available to advertisers. Because the model does not rely on assumptions, but rather is generated based on historical data, the model is consistent with actual advertiser behavior and provides a meaningful bid value forecast tool.

Although the subject matter has been described in language specific to structural features and/or methodological operations, it is to be understood that the subject matter defined in the appended claims is not necessarily limited to the specific features or operations described. Rather, the specific features and acts are disclosed as example forms of implementing the claims

What is claimed is:

1. A method comprising:
receiving a first bid value associated with an ad during a first time period;
recording a first performance indicator associated with the ad during the first time period;
receiving a second bid value associated with the ad during a second time period;
recording a second performance indicator associated with the ad during the second time period;
aggregating the first performance indicator with the second performance indicator to generate a historical behavior indicator associated with the ad; and
formulating a graphical model usable to forecast future bid values to be associated with the ad, the graphical model being based at least in part on the historical behavior indicator.

2. A method as recited in claim 1, wherein the ad is associated with a keyword, the method further comprising:
at least partly in response to receiving a search query, determining if the keyword is contextually relevant to the search query and causing display of the ad with search results at least partly in response to determining that the keyword is contextually relevant to the search query.

3. A method as recited in claim 1, wherein the first performance indicator is:
a number of impressions of the ad during the first time period;
a number of clicks on the ad during the first time period;
a total amount charged for the ad during the first time period;
an average cost per click associated with the ad during the first time period; or a campaign budget associated with the ad during the first time period.

4. A method as recited in claim 1, wherein the historical behavior indicator is:
a difference between a number of impressions of the ad during the first time period and a number of impressions of the ad during the second time period;
a difference between a number of clicks on the ad during the first time period and a number of clicks on the ad during the second time period;
a difference between the first bid value and the second bid value;
a difference between a total amount charged for the ad during the first time period and a total amount charged for the ad during the second time period;
a difference between an average cost per click associated with the ad during the first time period and an average cost per click associated with the ad during the second time period; or
a bid change frequency over a composite time period that includes the first time period and the second time period.

5. A method as recited in claim 1, wherein the graphical model is based at least in part on a latent Dirichlet allocation and provides a generative probabilistic model.

6. A method as recited in claim 1, wherein formulating the graphical model comprises:
determining a bid change distribution based at least in part on previous changes in bid values associated with the ad over a plurality of time periods;
defining a bid change status distribution based at least in part on the bid change distribution, the bid change status distribution defining a probability that the bid value will change for a next time period;
defining a change direction distribution based at least in part on the bid change distribution such that, in an event that the bid change status distribution indicates that the bid value will change for the next time period, the change direction distribution defines a probability that the bid value will increase for a next time period;
defining a function of at least one historical behavior indicator to model a magnitude of increase in an event that the change direction distribution indicates that the bid value will increase for the next time period;
defining a function of at least one historical behavior indicator to model a magnitude of decrease in an event that the change direction distribution indicates that the bid value will decrease for the next time period; and
defining a forecasted bid value based at least in part on a current bid value, a determined change direction, and a determined magnitude of change.

7. A method as recited in claim 6, wherein the bid change status distribution, z, is a Bernoulli distribution, z˜Ber(θ), where 8 represents the bid change distribution.

8. A method as recited in claim 6, wherein the change direction distribution, v, is a Bernoulli distribution, v˜Ber(λ), where is a historical change direction distribution. /

9. A method comprising:
receiving ads to be displayed with contextually relevant content, each of the ads having an associated bid value;
receiving requests to display content;
for each of the requests that is received, conducting an ad auction to select at least one of the ads to display with the requested content, wherein the at least one ad to display is selected based at least in part on the bid value associated with the at least one ad;
collecting data describing results of a plurality of the ad auctions that are conducted over a period of time; and
based at least in part on the collected data and on past changes of bid values over the period of time, creating a generative probabilistic model of advertiser behavior.

10. A method as recited in claim 9, wherein the generative probabilistic model is based at least in part on a latent Dirichlet allocation.

11. A method as recited in claim 9, further comprising using the generative probabilistic model to forecast a bid value for a particular one of the ads for an upcoming time period.

12. A method as recited in claim 11, wherein using the generative probabilistic model to forecast the bid value for the particular one of the ads for the upcoming time period comprises:
determining whether the bid value for the particular one of the ads will remain constant, increase, or decrease between the current time period and the upcoming time period;
in an event that it is determined that the bid value will remain constant between the current time period and the upcoming time period, forecasting the bid value for the particular one of the ads for the upcoming time period to be the same as the bid value for the particular one of the ads for the current time period;
in an event that it is determined that the bid value will increase from the current time period to the upcoming time period:
determining a magnitude by which the bid value will increase from the current time period to the upcoming time period; and
forecasting the bid value for the particular one of the ads for the upcoming time period to be equal to the bid value for the current time period, increased by the magnitude by which the bid value will increase from the current time period to the upcoming time period; and
in an event that it is determined that the bid value will decrease from the current time period to the upcoming time period:
determining a magnitude by which the bid value will decrease from the current time period to the upcoming time period; and
forecasting the bid value for the particular one of the ads for the upcoming time period to be equal to the bid value for the current time period, decreased by the magnitude by which the bid value will decrease from the current time period to the upcoming time period.

13. A method as recited in claim 12, wherein determining whether the bid value for the particular ad will remain constant, increase, or decrease between the current time period and the upcoming time period comprises:
determining, from the data describing results of the plurality of ad auctions, a frequency with which a bid value associated with the particular one of the ads has changed from one time period to a second, immediately subsequent time period;
based at least in part on the determined frequency, defining a change probability distribution; and
selecting a change status based at least in part on the change probability distribution, the change status indicating whether or not the bid value associated with the particular ad will change between the current time period and the upcoming time period, such that if a change status were selected an increasing number of times, a distribution of selected change status values would trend toward a distribution that corresponds to the change probability distribution.

14. A system comprising:
a search engine configured to:
receive a query;
search for content related to the query; and
return query results that include the content related to the query;
an ad auction module configured to:
receive <ad, keyword> pairs from advertisers, each of the <ad, keyword> pairs having an associated bid value;
for a particular one of the <ad, keyword> pairs:
associate a first bid value with the particular <ad, keyword> pair during a first time period;
receive an updated bid value for the particular <ad, keyword> pair; and
associate the updated bid value with the particular <ad, keyword> pair during a second time period;
at least partly in response to the search engine receiving the query:
identify an available ad slot in which a contextually relevant ad may be returned along with the query results;
select candidate ads based at least in part on a comparison of the query and keywords of the corresponding <ad, keyword> pairs of the candidate ads;
conduct an auction based at least in part on bid values associated with the <ad, keyword> pairs of the candidate ads; and
select a winning ad from the candidate ads, the winning ad being returned by the search engine along with the query results; and
an advertiser modeling module configured to:
record changes in bid values associated with the <ad, keyword> pairs over time;
record periodic performance indicators associated with the <ad, keyword> pairs;
aggregate the periodic performance indicators to record historical behavior indicators associated with the <ad, keyword> pairs; and
based at least in part on the changes in bid values and the historical behavior indicators, generate a model of advertiser behavior with regard to changes in bid values over time.

15. A system as recited in claim 14, wherein the model of advertiser behavior is a generative probabilistic model.

16. A system as recited in claim 14, wherein the model of advertiser behavior is based at least in part on a latent Dirichlet allocation.

17. A system as recited in claim 14, wherein the periodic performance indicators for a particular <ad, keyword> pair include:
a number of impressions of the ad;
a number of clicks on the ad;
a total amount charged for the <ad, keyword> pair; and
an average cost per click associated with the <ad, keyword> pair.

18. A system as recited in claim 14, wherein the historical behavior indicators for a particular <ad, keyword> pair include:
a difference between a number of impressions of the ad during the first time period and a number of impressions of the ad during the second time period;
a difference between a number of clicks on the ad during the first time period and a number of clicks on the ad during the second time period;
a difference between the first bid value and second bid value;
a difference between a total amount charged for the <ad, keyword> pair during the first time period and a total amount charged for the <ad, keyword> pair during the second time period; and
a difference between an average cost per click associated with the <ad, keyword> pair during the first time period and an average cost per click associated with the <ad, keyword> pair during the second time period.

19. A system as recited in claim 14, wherein the advertiser modeling module is further configured to determine a bid change distribution that defines, based at least in part on the changes in bid values, a probability that a bid value associated with a particular <ad, keyword> pair will change from one time period to a next time period.

20. A system as recited in claim 19, wherein the advertiser modeling module is further configured to determine a bid change direction distribution that defines, based at least in part on the changes in bid values, a probability that a bid value associated with a particular <ad, keyword> pair will increase from one time period to a next time period, given that the bid value will change from one time period to a next time period.
